(19) United States
(12) Patent Application Publication
(10) Pub. No.: US 2008/0240097 A1
(43) Pub. Date: Oct. 2, 2008

(54) APPARATUS AND METHOD FOR MULTICAST AND BROADCAST SERVICE (MBS) IN BROADBAND WIRELESS ACCESS SYSTEM

(75) Inventors: Ki-Back KIM, Seongnam-si (KR); Sang-Young Lee, Seoul (KR); Eun-Chan Park, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/059,379

(22) Filed: Mar. 31, 2008

(30) Foreign Application Priority Data
Mar. 30, 2007 (KR) 2007-0031259

(51) Int. Cl. H04L 12/56

(52) U.S. Cl. 370/390

(57) ABSTRACT

An apparatus and a method for a Multicast and Broadcast Service (MBS) in a Broadband Wireless Access (BWA) system are provided. A broadcasting server in a broadcasting service system includes a storage for storing broadcasting contents; a controller for determining relative offset information for a broadcasting start time with respect to each Internet Protocol (IP) packet; a generator for generating IP packets with the contents provided from the storage and recording the determined relative offset information in the generated IP packets; and a transmitter for transmitting the packets including the relative offset information to an Access Control Router (ACR).

### PRIORITY

This application claims priority under 35 U.S.C. § 119(a) to a Korean patent application filed in the Korean Intellectual Property Office on Mar. 30, 2007 and assigned Serial No. 2007-31259, the entire contents of which are incorporated herein by reference.

### BACKGROUND OF THE INVENTION

1. Field of the Invention

The present invention relates generally to an apparatus and a method for a Multicast and Broadcast Service (MBS) in a broadband wireless access system. More particularly, the present invention relates to a time synchronizing apparatus and method for macro diversity.

2. Description of the Related Art

Communication systems have generally been developed to provide a voice service and are now advancing to provide data service and various multimedia services in addition to the voice service. The voice oriented communication systems have not satisfied users' service needs due to the systems' relatively narrow transmission bandwidths and expensive fees. Additionally, communication industry advancements and users' increasing demand for Internet service raise the necessity for communication systems that efficiently provide Internet service. To respond to this demand, a Broadband Wireless Access (BWA) system has been developed with enough broadband to meet the users' increasing demand for an efficiently provided Internet service.

The BWA system integrally supports not only a voice service, but also multimedia application services such as various low and high-speed data services and high-definition video. The BWA system is a radio communication system capable of accessing a Public Switched Telephone Network (PSTN), a Public Switched Data Network (PSDN), the Internet, an International Mobile Telecommunications (IMT)-2000 network, and an Asynchronous Transfer Mode (ATM) network in a mobile or stationary environment based on radio media using broad bands of 2 GHz, 5 GHz, 26 GHz, and 60 GHz, and supporting a channel transfer rate over 2 Megabits per second (Mbps). The BWA system can be classified as a broadband wireless subscriber network, a broadband mobile access network, and a high-speed wireless Local Area Network (LAN) based on terminal mobility (stationary or mobile), the communication environment (indoor or outdoor), and the channel transfer rate.

Main services of the BWA system include Internet, Voice over Internet Protocol (VoIP), and non-real-time streaming services. Recently, Multicast and Broadcast Service (MBS), a real-time broadcasting service, is attracting attention as a new service. The MBS features mobility support and bi-directional communications, compared to a terrestrial Digital Multimedia Broadcasting (DMB).

The MBS is able to provide data services such as video broadcasting services for news, serial dramas, and sports, radio music broadcasting, and real-time traffic information. Due to a high data rate using the macro diversity, the MBS can transmit various channels of high-definition data and high-quality audio at the same time. Herein, the macro diversity indicates the same data transmission at the same time over the same frequency on an MBS zone basis.

FIG. 1 illustrates the macro diversity.

When a Mobile Station (MS) travels in a cell overlapping area, a signal from a neighbor cell acts as a signal gain by a Radio Frequency (RF) combining, rather than as noise due to interference. This is the macro diversity effect. However, to acquire the macro diversity effect, it is necessary for a serving Base Station (BS) and a BS (or Radio Access Station (RAS)) of the neighbor cell to send the same signal. Therefore, to provide the MBS, every BS in the MBS zone must transmit the same signal at the same time.

As discussed above, to provide the broadcasting service on the MBS zone basis, a time synchronizing method for every BS in the same MBS zone to transmit the same signal at the same time is required. Further, if the MBS zone covers two or more BS controllers (e.g., Access Control Routers (ACRs) or Access Service Network GateWays (ASN-GWs)), time synchronization between the BS controllers in the same MBS zone is required.

### SUMMARY OF THE INVENTION

An aspect of the present invention is to address at least the above-mentioned problems and/or disadvantages and to provide at least the advantages described below. Accordingly, an aspect of the present invention is to provide a time synchronizing apparatus and method between ACRs within the same MBS zone in a BWA communication system.

Another aspect of the present invention is to provide an apparatus and a method for providing an MBS in a BWA communication system.

Yet another aspect of the present invention is to provide time synchronizing apparatus and method for MBS in a BWA communication system.

Still another aspect of the present invention is to provide an apparatus and a method for every RAS in the same MBS zone to transmit the same data at the same time in a BWA communication system.

The above aspects are achieved by providing a broadcasting server in a broadcasting service system. The broadcasting server includes a storage for storing broadcasting contents; a controller for determining relative offset information for a broadcasting start time with respect to each Internet Protocol (IP) packet; a generator for generating IP packets with the broadcasting contents provided from the storage and recording the determined relative offset information in the generated IP packets; and a transmitter for transmitting the packets including the relative offset information to an Access Control Router (ACR).

According to one aspect of the present invention, an ACR in a broadcasting service system includes a controller for determining a time stamping time and an absolute broadcasting time to be stamped, using relative offset information recorded in a first packet received from a broadcasting server; a packetizer for generating a second packet by packetizing the first packet received from the broadcasting server according to air scheduling information; a time stamper for stamping absolute broadcasting time information in the second packet at the time stamping time; and a transmitter for multicasting the second packet including the absolute broadcasting time information, to RASs in a corresponding broadcasting zone.

According to another aspect of the present invention, a communication method of a broadcasting server in a broadcasting service system includes determining relative offset information for a broadcasting start time with respect to each IP packet; generating IP packets with broadcasting content data; recording the determined relative offset information in the generated IP packets; and transmitting the IP packets including the relative offset information to an ACR.

According to yet another aspect of the present invention, a communication method of an ACR in a broadcasting service system includes determining a time stamping time and an absolute broadcasting time to be stamped, using relative offset information recorded in a first packet received from a broadcasting server; generating a second packet by packetizing the first packet received from the broadcasting server according to air scheduling information; stamping the absolute broadcasting time information in the second packet at the time stamping time; and multicasting the second packet including the absolute broadcasting time information, to RASs in a corresponding broadcasting zone.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of the present invention will become more apparent from the following detailed description taken in conjunction with the accompanying drawings, in which:

FIG. 1 illustrates a macro diversity;

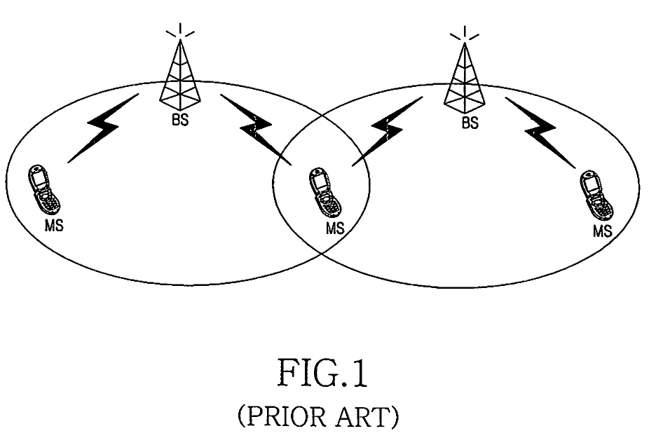

FIG. 2 illustrates a network structure for providing an MBS according to an exemplary embodiment of the present invention;

FIG. 3 illustrates an MCBCS server in detail according to an exemplary embodiment of the present invention;

FIG. 4 illustrates an ACR in detail according to an exemplary embodiment of the present invention;

FIG. 5 illustrates an RAS according to an exemplary embodiment of the present invention;

FIG. 6 illustrates operations of the MCBCS server according to an exemplary embodiment of the present invention;

FIG. 7 illustrates operations of the ACR according to an exemplary embodiment of the present invention; and

FIG. 8 illustrates operations of the RAS according to an exemplary embodiment of the present invention.

### DETAILED DESCRIPTION OF EXEMPLARY EMBODIMENTS

The following description is provided with reference to the accompanying drawings to assist in a comprehensive understanding of the present invention as defined by the claims and their equivalents. The description includes various specific details to assist in that understanding but these specific details are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The present invention provides a time synchronizing method between Access Control Routers (ACRs) within a same Multicast and Broadcast Service (MBS) zone in a Broadband Wireless Access (BWA) communication system that provides an MBS service.

To provide the MBS on an MBS zone basis, the Institute of Electrical and Electronics Engineers (IEEE) 802.16 standard defines an MBS zone IDentifier (ID) and a Multicast Connection ID (MCID). One MBS zone contains a group of RASs to acquire a macro diversity gain, and each MCID is a unique value for each broadcasting channel in the MBS zone. Herein, in different MBS zones, different broadcasting channels can have the same MCID, and the same broadcasting channels can have different MCIDs.

Hereinafter, the broadcasting service can be referred to as an MBS, a MultiCast and BroadCast Service (MCBCS), a Multimedia Broadcast and Multicast Service (MBMS), or a BroadCast/MultiCast Service (BCMCS), depending on the standardization group or an intention of an operator. Also, names of Network Entities (NEs) are defined according to the NEs' functions, and accordingly can be changed depending on the standardization group or an intention of the operator. For example, an RAS can be referred to as an Access Point (AP), a Base Station (BS), or a node-B. An ACR can be referred to as a Radio Network Controller (RNC), a Base Station Controller (BSC), or an Access Service Network (ASN)-GateWay (GW). Therefore, the ASN-GW can function as not only the RAS controller, but also as a router.

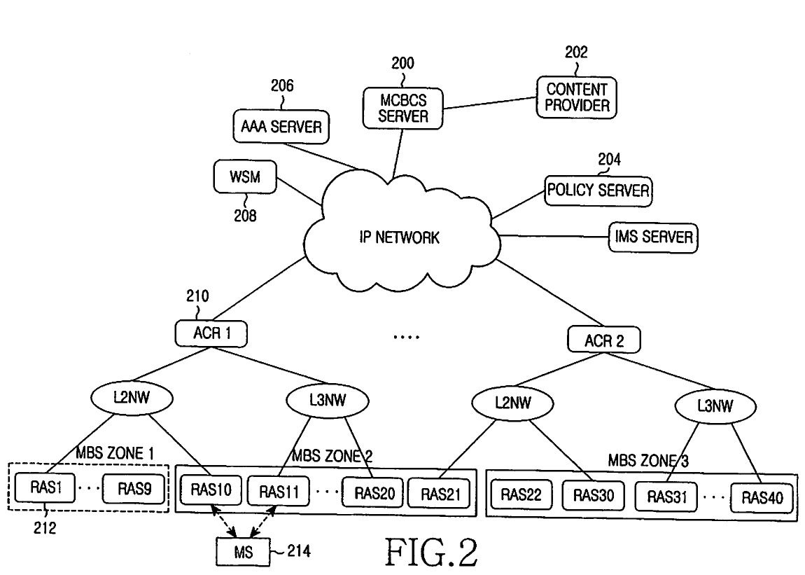

FIG. 2 illustrates a network structure for providing the MBS according to an exemplary embodiment of the present invention.

The network of FIG. 2 includes an MCBCS server 200, a content provider 202, a policy server 204, an Authentication, Authorization and Accounting (AAA) server 206, a WIreless BROadband (WiBro) System Manger (WSM) 208, an ACR 210, an RAS 212, and a Mobile Station (MS) 214. Herein, the ACR 210 and the RAS 212 can be defined as an Access Service Network (ASN).

The MCBCS server 200, for the MBS service, generates and stores contents and transmits corresponding MBS traffic to the ASN according to a request from the MS 214. The MCBCS server 200 includes interfaces with the external content provider 202 and the AAA server 206. When receiving a service request from the MS 214, the MCBCS server 200 informs the AAA server 206 of the request reception.

The AAA server 206 performs the authentication and the charging for the MS 214 in association with the MCBCS server 200. The AAA server 206 assists in generation of an encryption key of the contents in association with the MCBCS server 200, and periodically triggers a refresh of the encryption key.

The policy server 204 manages Quality of Service (QoS) information on an Internet Protocol (IP) flow basis. When an MBS for a specific MS is triggered, the policy server 204 provides the triggering information to the ASN through a Common Open Policy Service (COPS) interface.

The WSM 208 provides information relating to the MBS zone management to the ASN. More specifically, the WSM 208 provides the ASN with MBS zone configuration information of the ACRs and the RASs, air scheduling information (permutation, Modulation and Coding Scheme (MCS) level, presence or absence of Multiple Input Multiple Output (MIMO), data rate, transmission period, and compression), and Operations/Administration/Management (OAM) information (broadcasting start/end management information and time compensation parameters). The WSM 208 can be an Element Management System (EMS) or an Operating and Maintenance Center (OMC).

Herein, the ASNs 210 and 212, the AAA server 206, and the WSM 208 are present in the domain of an Access Service Provider (ASP).

The ACR 210 forwards the broadcasting contents from the MCBCS server 200 to the RAS 212. The ACR 210 manages the connection and the mobility of the MS 214, and generates unique Service Flows (SFs) for UpLink (UL) and DownLink (DL) connections. For instance, when the MBS triggering for the MS 214 is informed from the policy server 204, the ACR 210 provides information necessary for receiving the corresponding SF to the MS 214. Herein, the ACR 210 interfaces with the policy server 204 using the Common Open Policy Service (COPS) protocol.

The RAS 212 forwards the broadcasting contents from the ACR 210 to the MS 214. Herein, the RAS 212 is connected to the ACR 210 by cable and is connected to the MS 214 by radio. The RAS 212 allocates a resource to the MS 214 by scheduling based on the QoS of Media Access Control (MAC) layer.

The RAS 212 receives the time-stamped and packetized traffic from the ACR 210 according to the air scheduling information predefined for the MBS traffic, bypasses the received traffic at the time-stamped time, and then broadcasts the traffic. The time synchronization and the packetization for the MBS traffic can be performed by the ACR 210 or an MBS Controller (MBSC) of the MCBCS server 100.

As such, one MBS zone includes the plurality of RASs, and the RASs in the same MBS zone map the same broadcasting contents to the same resources and transmit the broadcasting contents at the same time.

Typically, since the MBS zone is allocated on a regional basis, a single MBS zone can cover a plurality of ACRs as shown in FIG. 2. This is referred to as multi-ACR macro diversity. Now, a time synchronizing method for the multi-ACR macro diversity is illustrated. Hereinafter, it is assumed that every ASN perform the MBSC functions (e.g., time synchronization and packetization). Herein, a specific ACR (ASN-GW) can conduct the MBSC functions on the MBS zone basis, and the ACR functioning as the MBSC can be defined as an anchor ACR.

The MCBCS server 200 records relative offset information relating to the broadcasting start time into IP packets corresponding to the broadcasting contents and provides the IP packets to the ACR 210. The relative offset information relating to the broadcasting start time can be recorded in a Generic Routing Encapsulation (GRE) header of the IP packet exchanged over a backbone network. When one MBS zone covers the multiple ACRs as in the MBS zone 2, each ACR 210 independently acquires the time, packetizes the IP packets according to the air scheduling information, and stamps time in each packetized IP packet. As the ACR 210 is aware of the broadcasting start/end time for each broadcasting channel, the ACR 210 can stamp the time using the relative offset information according to the same rule. As the ACR 210 already knows the air scheduling information (permutation, MCS level, and transmission period) as well, the ACR 210 can packetize the IP packets using the same rule. Herein, it is assumed that an MBS MAP message is generated at each ASN (or ACR or RAS).

As described above, the MCBCS server 200 may record the relative offset information in every IP packet and send the IP packets. Alternatively, the MCBCS server 200 may transmit a dummy packet containing the relative offset information relating to the broadcasting start time in between the IP packets, to the ACR 210.

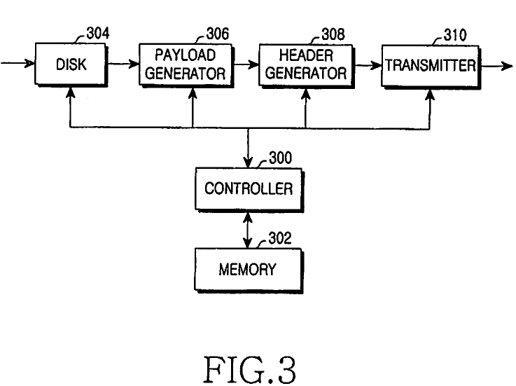

FIG. 3 illustrates the MCBCS server 200 in detail according to an exemplary embodiment of the present invention.

The MCBCS server 200 of FIG. 3 includes a controller 300, a memory 302, a disk 304, a payload generator 306, a header generator 308, and a transmitter 310.

The controller 300 controls the overall operation of the MCBCS server 200. The memory 302 stores programs for controlling the operations of the MCBCS server 200 and data generated during program execution. The memory 302 can store a service guide for the MBS.

The disk 304 contains the contents obtained from the external content provider 202 and its created contents, and outputs the corresponding content data to the payload generator 306 under the control of the controller 300. The payload generator 306 generates a payload of each IP packet by splitting the content data provided from the disk 304.

The header generator 308 generates a header (IP header) for each payload generated at the payload generator 306, generates the IP packet by adding the generated header to the payload. According to the exemplary embodiment of the present invention, the header generator 308 records the relative offset information relating to the absolute broadcasting start time into the header of each IP packet. Herein, the relative offset indicates the difference (the offset) between the broadcasting start time and the wireless transmission time of the data of the corresponding IP packet.

The transmitter 310 encodes the IP packet output from the header generator 308 in a physical layer and transmits the IP packet to the ACR.

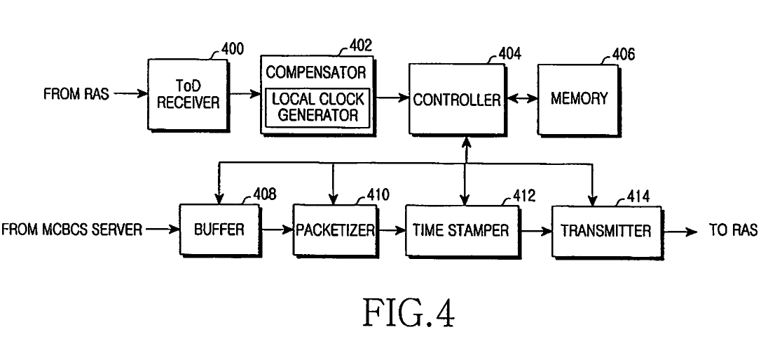

FIG. 4 illustrates the ACR in detail according to an exemplary embodiment of the present invention.

The ACR of FIG. 4 includes a Time of Date (ToD) receiver 400, a compensator 402, a controller 404, a memory 406, a buffer 408, a packetizer 410, a time stamper 412, and a transmitter 414.

The controller 400 controls the overall operation of the ACR 210. The memory 400 stores programs for controlling the operations of the ACR 210 and data generating in the program execution. The memory 406 also stores information relating to the MBS zone. Herein, the MBS zone information can include, for example, a list of ACRs in the MBS zone, the air scheduling information (permutation scheme, MCS level, transmission period, and two-dimensional burst allocation information) of the broadcasting channels, and flow management information (MCID, MBS zone ID, and IP address of the broadcasting channel).

The ToD receiver 400 receives time ToD information from the RAS. Typically, as a Global Positioning System (GPS) receiver is provided in the RAS, the ACR should acquire the time information from the RAS. If the ACR includes the GPS receiver, the acquisition of the time information from the RAS can be omitted. The ACR can acquire the time information from one of the ACR's managing RASs or from the plurality of the RASs. In the latter case, the ACR can select and use one reliable ToD information (e.g., the first arrived ToD information) among the received time information.

The compensator 402 compensates for a counter ACR_ToD of a local clock using the time information RAS_ToD provided from the ToD receiver 400. The compensator 402 verifies the time information RAS_ToD received from the RAS. When the time information is normal, the compensator 402 uses the received RAS_ToD to compensate for ACR_ToD. Otherwise, the compensator 402 ignores RAS_ToD received. The compensator 402 provides the counter ACR_ToD of the local clock to the controller 404. The controller 404 controls the stamping operation of the time stamper 412 based on the ACR_ToD provided from the compensator 402.

The compensation of the counter of the local clock is explained in further detail as follows. In the following algorithm, after the counter of the local clock is corrected, a reference time is determined by adding the corrected ACR_ToD and the total time error. Then the time stamping is performed based on the reference time.
Error_Threshold=time acquisition period/2: Error_count=0; Recovery_count=2;
If RAS_ToD >=ACR_ToD and IRAS_ToD-ACR_ToD|<Error_threshold, then
ACR_ToD=RAS_ToD and do time stamping with (ACR_ToD+total time error)
Else if RAS_ToD<ACR_ToD and IRAS_ToD-ACR_ToD|<Error_Threshold, then
ACR_ToD holds during interval of (ACR_ToD−RAS_TOD) and
do time stamping with (ACR_ToD+total time error)
Else if Error_count <=Recovery_count, then
do time stamping with (ACR_ToD+total time error) and Error_count=Error_count+1
Else
ACR_ToD=RAS_ToD and do time stamping with (ACR_ToD+total time error) and Error_count=0

The total time error can be calculated by below Equation (1):

total time error=time acquisition error (from RAS to ACR)+transmission error (source ACR to target RAS)+processing delay (1)

There is a backhaul network between the ACR and the RAS. While the deviation of the total time error may be severe depending on the backhaul network, the interface delay between the ACR and the RAS is mostly defined to below tens of ms. Generally, the interface delay is approximately 10 ms. In this exemplary embodiment of the present invention, it is assumed that the interface delay is less than 70 ms by a margin. Provided that the processing delay is less than 60 ms, the total time error is 200 ms. Namely, the MBS traffic is transmitted to the RAS in advance by stamping the time as the reference time that sums the corrected ACR_Tod and the total time error. The resultant total time error can be adjusted by a provider within a memory limit value of a channel card of the RAS, i.e., the corresponding parameter is defined in a Program Loading Data (PLD) list of the system manager so that the provider can modify the total time error through the system manager. Naturally, if an interface between the MCBCS server and the system manager exists, the total time error can be modified through the MCBCS server.

The buffer 408 buffers the IP (R3 IP) packets containing the broadcasting contents (MBS data) received from the MCBCS server 200, and outputs the buffered IP packets to the packetizer 410 under the control of the controller 404.

The packetizer 410 packetizes the IP packets output from the buffer 408 according to the air scheduling information (permutation scheme, MCS level, transmission period, and two-dimensional burst allocation information). Herein, the packetization covers the packing and the fragmentation and accordingly, generates a packet in accordance with the MBS burst wirelessly transmitted. In other words, the packet generated through the packetization is wirelessly transmitted right away without going through the packing or the fragmentation at the RAS.

The time stamper 412 stamps the corresponding transmission time information on each packet output from the packetizer 410 under the control of the controller 404. Herein, the transmission time information stamped on the packets is the absolute time for the wireless transmission and can be determined at the controller 404 or the time stamper 412. The controller 400 determines the transmission time stamped on each packetized packet using the broadcasting start time and the relative offset information stamped on the R3 IP packets.

The transmitter 414 encodes the time-stamped packets output from the time stamper 412 in the physical layer and transmits the time-stamped packets to the RASs in the same MBS zone. In specific, the transmitter 414 multicasts the time-stamped packets to the RASs in the same MBS zone.

In FIG. 4, if the modules 410 and 412 for the time stamping suffer from errors, the modules 410 and 412 can be duplexed. For the stability, the modules 400 and 402 for the time acquisition can be duplicated.

Meanwhile, the network between the ACR and the RAS can be configured as a Layer (L)2 network as shown in FIG. 2, or as a L3 network. In the L2 network, the ACR designates the highest priority traffic when marking a Class of Service (CoS) on the MBS packets. In the L3 network, the RAS designates the highest priority traffic when marking a Differentiated Service Code Point (DSCP) on the packets. This reduces the time delay to accomplish macro diversity.

For the multicast routing between the ACR and the RAS, the ACR should have a Protocol Independent Multicast (PIM) function. The RASs can join the ACR using an Internet Group Management Protocol (IGMP).

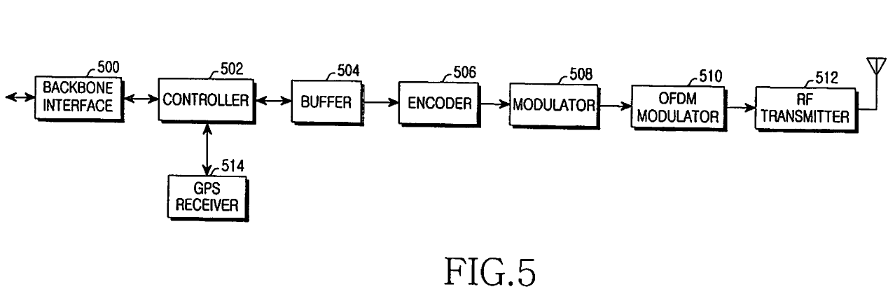

FIG. 5 illustrates the RAS according to an exemplary embodiment of the present invention.

The RAS of FIG. 5 includes a backbone interface 500, a controller 502, a buffer 504, an encoder 506, a modulator 508, an Orthogonal Frequency Division Multiplexing (OFDM) modulator 510, a Radio Frequency (RF) transmitter 512, and a GPS receiver 514.

The backbone interface 500 processes the signals (e.g., R6 interface signals) interfaced between the ACR 210 and the RAS 212. Specifically, the backbone interface 500 decodes the signal received through the backbone (or the backhaul) in the physical layer and provides the received packets (e.g., MBS packets) to the controller 502, and encodes the packet (or a message) from the controller 502 in the physical layer and transmits the encoded packet to the backbone.

The controller 502 processes the packet received via the backbone as a MAC Packet Data Unit (PDU) and stores the MAC PDU to the buffer 504. In doing so, without the packing or the fragmentation, one MBS packet is mapped to one MAC PDU. The MBS packets received via the backbone are stored to the buffer 504.

The GPS receiver 514 acquires the ToD time information by processing a signal received from a GPS satellite and provides the time information to the controller 502. The controller 502 controls the transmission time of each packet stored in the buffer 504 based on the time information.

The buffer 504 holds the packets (MAC PDUs) from the controller 502 and outputs the packets under the control of the controller 502. The encoder 506 encodes the packet fed from the buffer 504 according to a set MCS level. The modulator 508 modulates the data fed from the encoder 506 according to the set MCS level. The OFDM modulator 510 Inverse Fast Fourier Transform (IFFT)-processes data output from the modulator 508 and outputs sample data (OFDM symbols). The RF transmitter 512 converts the sample data output from the OFDM modulator 510 to an analog signal, converts the analog signal to an RF signal, and transmits the RF signal over an antenna.

The controller 502 provides the ToD time information to the ACR 210 at a set time interval. The controller 502 determines the necessary buffering space by taking into account the buffering time (e.g., 200 ms) of the packet and the data rate of the broadcasting channel, and provides the determined buffering space in advance before the broadcasting start time. For example, for the broadcasting channel with the data rate of 512 Kbps, the buffering space of 512 Kbps*0.2=102.4 Kbit is required. When the buffer 504 buffers the MBS traffic together with the unicast traffic, the buffer 504 is managed with the highest priority in the MBS traffic. If the total volume of the unicast traffic is greater than a threshold, the controller 502 limits the buffer occupation of the QoS flow (e.g., best effort traffic) of the lowest priority. The threshold can be determined by computing the buffering space for each broadcasting channel and summing up all the computed buffering spaces.

The controller 502 performs stop and replay functions to avoid the overflow of the buffer 504. More specifically, the controller 502 presets a stop threshold and a replay threshold for each broadcasting channel. When data exceeding the stop threshold is stored to the buffer for the corresponding broadcasting channel, the controller 502 sends a transmission stop request to the ACR 210 to prevent the buffer overflow. By contrast, when the buffer storage is less than the replay threshold, the controller 502 sends a transmission replay request to the ACR 510.

The relation between the thresholds is:

stop threshold>replay threshold>=necessary minimum buffering area

The replay threshold can also be used to request the replay after the transmission stop. The buffer storage may fall below the replay threshold not in the transmission stop. In this case, the controller 502 can temporarily request further data to the ACR 210. Note that the average data rate of the MBS traffic between the ACR 210 and the RAS 212 should sustain the value set by the provider. The provider can set the interval parameter required to compute the average data rate.

The controller 502 compares the transmission time information stamped on the packet received over the network with the ToD of the ACR. When the controller 502 determines that the difference is greater than a threshold, the controller 502 informs the ACR 210 and the WSM 208 of this determination. Using this alarm function, it is possible to prevent the ACR 210 from the abnormal operation.

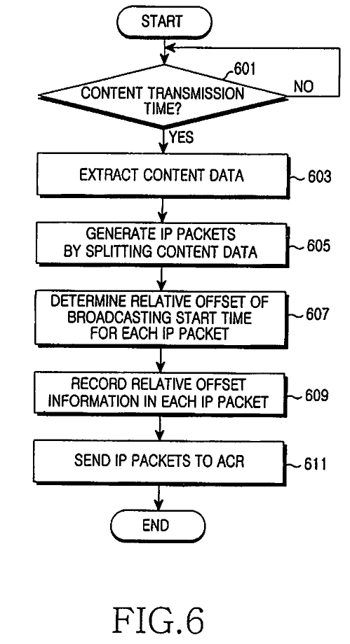

FIG. 6 illustrates operations of the MCBCS server 200 according to an exemplary embodiment of the present invention.

In step 601, the MCBCS server 200 checks whether the current time is the content transmission time. The MCBCS server 200 holds the service guide (including the broadcasting schedule and the mapping table), and checks the content transmission time based on the service guide. At the content transmission time, the MCBCS server 200 extracts the corresponding content data from the disk in step 603.

In step 605, the MCBCS server 200 generates IP packets with the extracted content data. In step 607, the MCBCS 200 determines the relative offset for the broadcasting start time with respect to each IP packet. The relative offset indicates the difference between the broadcasting start time and the wireless transmission time of the data of the corresponding IP packet.

In step 609, the MCBCS server 200 records the determined relative offset information in each IP packet. The relative offset information can be recorded in the GRE header of the IP packet exchanged over the backbone network.

After generating the IP packets containing the broadcasting contents, the MCBCS server 200 multicasts the IP packets to the ACRs in step 611.

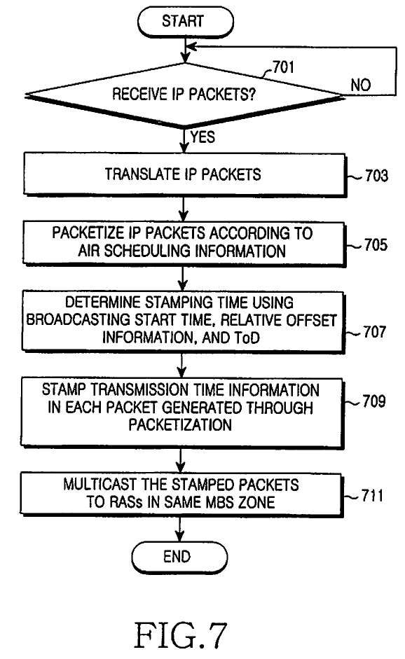

FIG. 7 illustrates operations of the ACR 210 according to an exemplary embodiment of the present invention.

In step 701, the ACR 210 checks whether the IP packets are received from the IP network. Upon receiving the IP packets, the ACR 210 translates the received IP packets in step 703. In doing so, the ACR 210 can confirm that the IP packets include the broadcasting contents.

In step 705, the ACR 210 packetizes the IP packets according to the air scheduling information (permutation scheme, MCS level, and two-dimensional burst allocation information) of the corresponding broadcasting channel. Herein, the packetization covers the packing and the fragmentation, and generates the packet fit for the MBS burst wirelessly transmitted, i.e., the packet generated through the packetization can be wirelessly transmitted without the packing or the fragmentation at the RAS.

After the packetization, the ACR 210 determines the time stamping time using the ToD acquired from the RAS, the relative offset information written in the IP packet received over the network, the wireless transmission period, and the broadcasting start time, in step 707.

In step 709, the ACR 210 stamps the transmission time information in the packet generated through the packetization at the determined time stamping time. The transmission time information indicates the absolute time of the radio transmission. In step 711, the ACR 210 multicasts the packets including the transmission time information to the RASs in the same MBS zone.

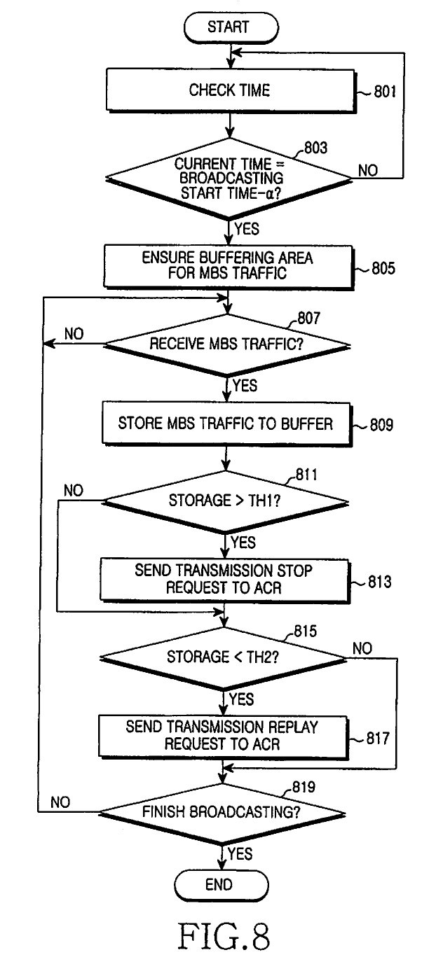

FIG. 8 illustrates operations of the RAS 212 according to an exemplary embodiment of the present invention. Particularly, FIG. 8 illustrates the operations of the stop and replay functions to avoid a buffer overflow.

In step 801, the RAS 212 checks the current time. The current time can be acquired using the GPS time information of the OAM block. In step 803, the RAS determines whether the current time arrives at a broadcasting start time −α.

When the current time arrives at the preset time prior to the broadcasting start time, the RAS 212 reserves the buffering space for the MBS traffic in step 805. The necessary buffering space is determined by taking into account the buffering time (e.g., 200 ms) of the MBS packets and the data rate of the broadcasting channel, and reserves the determined buffering space in advance before the broadcasting start time. If the MBS traffic and the unicast traffic are buffered together as one buffer, the buffer management gives the highest priority to the MBS traffic. If the total volume of the unicast traffic is greater than a threshold, the RAS 212 can reserve the necessary buffering space by restricting the buffer occupation of the traffic (e.g., best effort traffic) of the flow of the lowest priority.

In step 807, the RAS 212 checks whether the MBS traffic is received from the ACR 210. When receiving the MBS traffic, the RAS 212 stores the MBS traffic received from the ACR 210 to the buffer in step 809.

In step 811, the RAS 212 compares the buffer storage of the MBS traffic with the stop threshold TH1. When the buffer storage is greater than the stop threshold TH1, the RAS 212 sends the transmission stop request to the ACR 210 in step 813. In response to the transmission stop request, the ACR 210 stops the MBS traffic transmission to the RAS 212.

In step 815, the RAS 212 compares the buffer storage of the MBS traffic with the replay threshold TH2. When the buffer storage is less than the replay threshold TH2, the RAS 212 sends the transmission replay request to the ACR 210 in step 817. In response to the transmission replay request, the ACR 210 replays the MBS traffic transmission to the RAS 212. When the buffer storage falls below the replay threshold TH2 not in the transmission stop state, the RAS 212 can temporarily request further MBS traffic to the ACR 210 in step 817.

There is some time delay between the transmission stop/replay request from the RAS and the MBS traffic transmission stop/replay at the ACR in reply to the request. To avoid the excessive transmission stop/replay requests, the request message is sent to the ACR only when a certain time delay elapses from the previous message transmission by taking into account the time delay, rather than sending the transmission stop/replay request message upon every MBS packet reception.

In step 819, the RAS 212 checks whether the broadcasting is finished, by checking the time. When the broadcasting is complete, the RAS 212 finishes this process. By contrast, still in the broadcasting, the RAS 212 goes back to step 807 to continue to receive the MBS traffic, and performs the subsequent steps.

In this embodiment of the present invention, when the plurality of ACRs belongs to one MBS zone, the ACRs function as the MBSC. Alternatively, when the plurality of the ACRs belongs to one MBS zone, one ACR can serve as the master MBSC and multicast the packets generated through the MBSC function to all the RASs in the MBS zone. That is, the master ACR can transmit the MBS traffic to the RASs controlled by another ACR through the multicast routing, without passing through the other ACR. This is the case where the backhaul between the ACR and the RAS is the L3 or L2 network.

As an example, the master ACR can be determined as the ACR including the greatest number of the RASs, or as the ACR having the smallest time acquisition error. Namely, the master ACR can be determined according to various rules. The provider manages the overall MBS zone. When the zone allocation and the master ACR of the corresponding zone are determined, the zone configuration information is sent to the ANS at the initial setup and in every setup change. In doing so, when an interface between the MCBCS server 200 and the ACR 212 exists, the zone configuration information is transmitted through this interface. When there is no interface, the WSM, the EMS or the OMC provides the zone configuration information to the ASN. When the interface is present between the MCBCS server 200 and the WSM, the zone configuration information may be forwarded through the MCBCS server-the WSM-the ASN.

As set forth above, in the BWA system which provides the MBS, the time synchronization can be achieved between the ACRs in the same MBS zone. Even when the same MBS zone covers the multiple ACRs, the macro diversity gain can be obtained. When the time synchronization is attained between the ACRs, the coverages of the ACRs can be constituted as one MBS zone. Therefore, the flexible MBS zone can be configured.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A broadcasting server in a broadcasting service system, comprising:
a storage for storing contents;
a controller for determining relative offset information for a broadcasting start time with respect to each Internet Protocol (IP) packet;
a generator for generating IP packets with the contents provided from the storage and recording the determined relative offset information in the generated IP packets; and
a transmitter for transmitting the IP packets including the relative offset information to an Access Control Router (ACR).

2. The broadcasting server of claim 1, wherein the relative offset is a difference between the broadcasting start time and a wireless transmission time of data of a corresponding IP packet.

3. The broadcasting server of claim 1, wherein the relative offset information is recorded in a Generic Routing Encapsulation (GRE) header of the IP packet.

4. The broadcasting server of claim 1, wherein the broadcasting service is a Multicast and Broadcast Service (MBS).

5. An Access Control Router (ACR) in a broadcasting service system, comprising:
a controller for determining a time stamping time and an absolute broadcasting time to be stamped, using relative offset information recorded in a first packet received from a broadcasting server;
a packetizer for generating a second packet by packetizing the first packet received from the broadcasting server according to air scheduling information;
a time stamper for stamping the absolute broadcasting time information in the second packet at the time stamping time; and
a transmitter for multicasting the second packet including the absolute broadcasting time information, to Radio Access Stations (RASs) in a corresponding broadcasting zone.

6. The ACR of claim 5, wherein the relative offset is a difference between a broadcasting start time and a wireless transmission time of data of the first packet.

7. The ACR of claim 5, wherein the controller determines a reference time using a Global Positioning System (GPS) information, and controls the time stamping operation using the determined reference time.

8. The ACR of claim 7, further comprising:
a compensator for correcting a counter of a local clock using the GPS information received from the RASs and determining the reference time using the corrected counter.

9. The ACR of claim 5, further comprising:
a memory for storing broadcasting zone information.

10. The ACR of claim 9, wherein the broadcasting zone information comprises air scheduling information and flow management information of broadcasting channels.

11. The ACR of claim 5, wherein the controller determines the time stamping time and the absolute broadcasting time using the relative offset information recorded in the first packet received from the broadcasting server, a wireless packet transmission period, and a broadcasting start time, and
directs the time stamper to stamp the absolute broadcasting time when a reference time arrives at the time stamping time.

12. A Radio Access Station (RAS) in a broadcasting service system, comprising:
a buffer for buffering Multicast and Broadcast Service (MBS) traffic received from an Access Control Router (ACR); and
a controller for, when a buffer storage of the MBS traffic is greater than a first threshold, sending a transmission stop request to the ACR, and, when the buffer storage is less than a second threshold, sending a transmission replay request to the ACR.

13. The RAS of claim 12, wherein the controller compares the buffer storage with the second threshold while receiving the MBS traffic, and, when the buffer storage is less than the second threshold, temporarily requests further MBS traffic to the ACR.

14. The RAS of claim 12, wherein, before the broadcasting start time, the controller reserves a buffering area for the MBS traffic.

15. The RAS of claim 12, further comprising:
an encoder and a modulator for encoding and modulating the MBS traffic output from the buffer according to a Modulation and Coding Scheme (MCS) level;
an Orthogonal Frequency Division Multiplexing (OFDM) modulator for Inverse Fast Fourier Transform (IFFT)-processing data output from the modulator by mapping the data to resources allocated for the MBS; and
a transmitter for converting the data output from the OFDM modulator to a Radio Frequency (RF) signal and transmitting the RF signal.

16. A communication method of a broadcasting server in a broadcasting service system, the method comprising:
determining relative offset information for a broadcasting start time with respect to each Internet Protocol (IP) packet;
generating IP packets with broadcasting content data;
recording the determined relative offset information in the generated IP packets; and
transmitting the IP packets including the relative offset information to an Access Control Router (ACR).

17. The communication method of claim 16, wherein the relative offset is a difference between the broadcasting start time and a wireless transmission time of data of a corresponding IP packet.

18. The communication method of claim 16, wherein the relative offset information is recorded in a Generic Routing Encapsulation (GRE) header of the IP packets.

19. The communication method of claim 16, wherein the broadcasting service is a Multicast and Broadcast Service (MBS).

20. A communication method of an Access Control Router (ACR) in a broadcasting service system, the method comprising:
determining a time stamping time and an absolute broadcasting time to be stamped, using relative offset information recorded in a first packet received from a broadcasting server;
generating a second packet by packetizing the first packet received from the broadcasting server according to air scheduling information;
stamping the absolute broadcasting time information in the second packet at the time stamping time; and
multicasting the second packet including the absolute broadcasting time information, to Radio Access Stations (RASs) in a corresponding broadcasting zone.

21. The communication method of claim 20, wherein the relative offset is a difference between a broadcasting start time and a wireless transmission time of data of the first packet.

22. The communication method of claim 20, further comprising:
determining a reference time using time information of a Global Positioning System (GPS); and
controlling the time stamping operation using the determined reference time.

23. The communication method of claim 22, wherein determining the reference time comprises:
acquiring GPS time information from the ACR;
correcting a counter of a local clock using the GPS time information acquired from the RASs; and
determining the reference time using the corrected counter.

24. The communication method of claim 20, further comprising:
storing broadcasting zone information.

25. The communication method of claim 24, wherein the broadcasting zone information includes air scheduling information and flow management information of broadcasting channels.

26. The communication method of claim 20, wherein the time stamping time is determined using the relative offset information recorded in the first packet, a wireless packet transmission period, and the broadcasting start time.

27. The communication method of claim 20, wherein the air scheduling information includes at least one of a permutation scheme, a Modulation and Coding Scheme (MCS) level, presence or absence of Multiple Input Multiple Output (MIMO), and two-dimensional burst allocation information.

28. A communication method of a Radio Access Station (RAS) in a broadcasting service system, the method comprising:
buffering Multicast and Broadcast Service (MBS) traffic received from an Access Control Router (ACR);
sending a transmission stop request to the ACR when a buffer storage of the MBS traffic is greater than a first threshold; and
sending a transmission replay request to the ACR when the buffer storage is less than a second threshold.

29. The communication method of claim 28, further comprising:
comparing the buffer storage with the second threshold while receiving the MBS traffic; and
when the buffer storage is less than the second threshold, temporarily requesting further MBS traffic to the ACR.

30. The communication method of claim 28, further comprising:
before the broadcasting start time, reserving a buffering area for the MBS traffic.

31. The communication method of claim 28, further comprising:
encoding and modulating the MBS traffic output from a buffer according to a Modulation and Coding Scheme (MCS) level;
generating Orthogonal Frequency Division Multiplexing (OFDM) symbols by Inverse Fast Fourier Transform (IFFT)-processing the modulated data; and
converting the OFDM symbols to a Radio Frequency (RF) signal and transmitting the RF signal.
